(19) United States
(12) Patent Application Publication
(10) Pub. No.: US 2010/0082662 A1
(43) Pub. Date: Apr. 1, 2010

(54) Information Retrieval System User Interface

(75) Inventors: Stuart Taylor, Cambridge (GB); Shahram Izadi, Cambridge (GB); Richard Harper, Cambridge (GB); Richard Banks, Egham (GB); Abigail Sellen, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/238,169

(22) Filed: Sep. 25, 2008

(51) Int. Cl. G06F 3/048; G06F 17/30

(52) U.S. Cl. 707/769; 715/764; 707/E17.014

(57) ABSTRACT

A user interface for an information retrieval system is described. In an embodiment an output region for showing retrieved documents is displayed on an interactive surface. One or more movable user interface items, such as digital buttons or tangible objects, may be positioned in an active region. Each movable user interface item has a stored query associated with it and for example, the queries may be words or images. In an embodiment a user interface controller apparatus identifies any movable user interface items in the active region and identifies a spatial relationship between those items and the output region. In an embodiment, a query is accessed for each of the user interface items in the active region and those queries and the information about the spatial relationship are used to retrieve documents from a document database.

### BACKGROUND

Existing information retrieval systems such as web search systems, data centre access systems, database systems, PC file search systems and the like are typically operated by entering search queries such as key words by typing these into a dialog box on a graphical user interface. The queries are used by a search engine or similar process to retrieve documents or other items of information and present a ranked list of results to the user.

Without accessing an “advanced search” dialog screen the user typically has little additional control over the search criteria and is only able to enter search terms, perhaps with the use of wildcards. As a result the search results often include items which are not relevant to the user. Also, typical information retrieval systems are designed to be operated by a single user who is required to think of appropriate query terms him or herself and to tailor those query terms to generate appropriate search results. This requires skill on the part of the user and several attempts at query terms may be necessary before appropriate search results are found.

There is a desire to improve the ease and speed of use of such information retrieval systems and to improve the relevance of the results.

The embodiments described below are not limited to implementations which solve any or all of the problems mentioned above.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A user interface for an information retrieval system is described. In an embodiment an output region for showing retrieved documents is displayed on an interactive surface such as a multi-touch screen. One or more movable user interface items which are for example, digital buttons or tangible objects, may be positioned in an active region. For example, the active region is around or adjacent to the output region. Each movable user interface item has a stored query associated with it and for example, the queries may be words or images. In an embodiment a user interface controller apparatus identifies any movable user interface items in the active region and identifies a spatial relationship between those items and the output region. For example, the spatial relationship may comprise distances of the movable user interface items from the output region. In an embodiment, a query is accessed for each of the user interface items in the active region and those queries and the information about the spatial relationship are used to retrieve documents from a document database. In an embodiment, distances of the movable user interface items from the output region are used to weight the associated queries. For example, a group of users are able to collaborate in positioning movable user interface items on an interactive surface in order to obtain relevant search results.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an information retrieval system;

FIG. 2 is a schematic diagram of a display of a user interface of the information retrieval system;

FIG. 3 is a schematic diagram of another display of a user interface of the information retrieval system;

FIG. 4 is a schematic diagram of another user interface of an information retrieval system;

FIG. 5 is a schematic diagram of another display of an information retrieval system;

FIG. 6 is a block diagram of a computer-implemented method at an information retrieval system;

FIG. 7 illustrates an exemplary computing-based device in which embodiments of a user interface controller may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a user interface for a web search system, the system described is provided as an example and not a limitation. As those skilled in the art will appreciate, the present examples are suitable for application in a variety of different types of information retrieval systems.

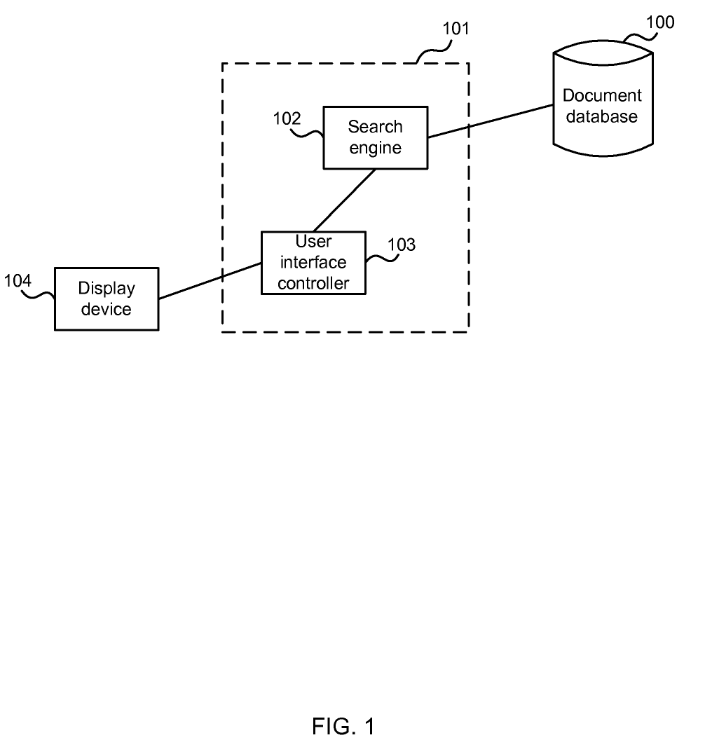

FIG. 1 is a schematic diagram of an information retrieval system 101 comprising a search engine 102 connected to a user interface controller 103. The search engine is connected to a document database 100 which may be integral with the information retrieval system although this is not essential as indicated in FIG. 1. The user interface controller 103 is connected to a display device 104.

The document database is any memory or storage apparatus which holds a plurality of documents of any type. The term “document” is used to refer to any item of information and a non exhaustive list of examples is: file, digital image, email, voice mail, audio file, video file, text file, text message, web page, map.

The search engine 102 is computer implemented and is arranged to store and implement one or more ranking functions or other algorithms to retrieve a ranked list of documents from the document database 100. The search engine 102 is arranged to receive inputs from a user interface controller 103 and those inputs comprise one or more queries to be used by the search engine 102 in order to retrieve the ranked list of documents. Any suitable type of search engine may be used as known in the art.

The user interface controller 103 is computer implemented and is arranged to control a display device 104 as well as to communicate with the search engine 102. The user interface controller 103 may also communicate directly with the document database 100.

The display device 104 is any suitable apparatus for presenting an output region in which information from the ranked list of documents may be presented. The display device 104 is also arranged to provide an active region within which user inputs may be received. Thus in all examples, the display device provides an interactive surface in that a user is able to make inputs at a surface provided by the display device.

For example, the display device 104 may be a multi-touch display screen which is a display screen that is able to detect two or more simultaneous contacts with the screen, for example, hand or finger contacts. In some examples, the display device 104 may comprise a projector arranged to project a display onto a surface and a camera arranged to capture images of the display. The display device may comprise tangible objects which may be placed on the surface such that images of those tangible objects may be captured by the video camera. In other examples, it is possible to use a multi-touch display achieved through mechanical means in combination with optical means such as a projector and/or camera arrangement. However, it is not essential to use a multi-touch display screen. Any display device may be used such as a conventional personal computer having a keyboard, mouse and display screen.

The user interface controller 103 is arranged to control the display device such that at least one output region is presented. This output region is arranged to display results of information retrieval processes carried out by the search engine 102. The user interface controller 103 is also arranged to control the display device such that at least one active region is provided on the interactive surface. The active region is arranged to receive user input in any suitable manner. For example, by detecting a tangible object placed in the active region and/or by detecting one or more hand or finger movements in or just above the active region of the interactive surface. In some examples, the active region is adjacent to the output region and in some examples the active region encompasses the output region although this is not essential. In the examples described herein the active region is contiguous although this is not essential.

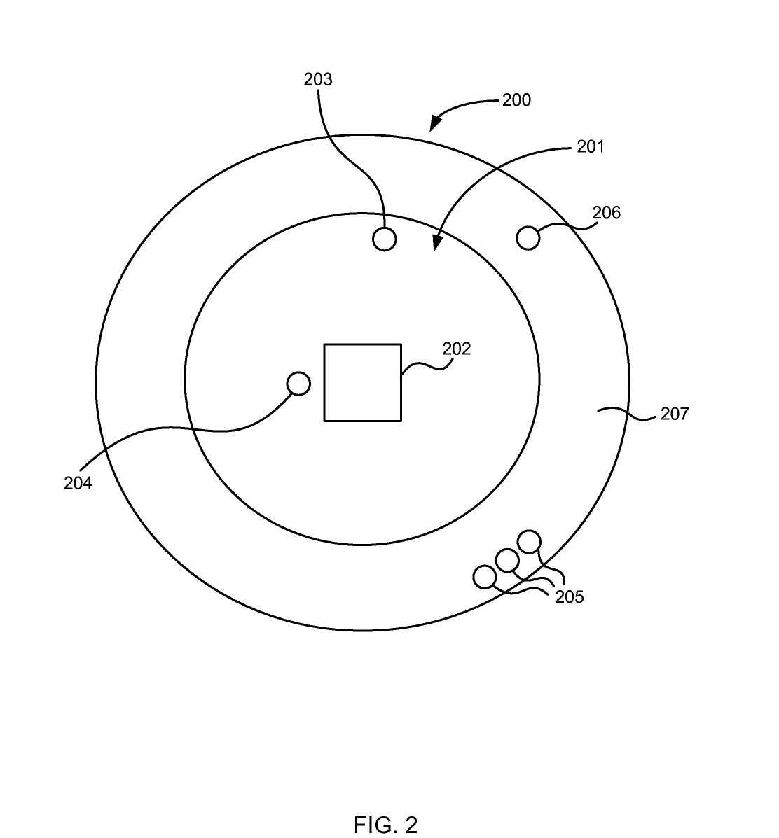

FIG. 2 is a schematic diagram of an interactive surface 200 provided by the display device 104. An output region 202 is presented as described above and an active region 201 encompasses the output region 202 in this example. An inactive region 207 is also provided in this example although the inactive region is not essential. The inactive region in this example encompasses the active region 201. One or more movable user interface items 203, 204, 205, 206 are provided and in this example these are shown as circular digital buttons. The movable user interface items may be physical objects in the case that the display device 104 provides for the use of tangibles as mentioned above. The movable user interface items may also be digital objects of any suitable shape such as circle, square, diamond, triangle, oval, rectangle or the like. The movable user interface items may also be physical objects in combination with digital objects. For example, a digital object may be rendered beneath a transparent physical object such that when a user moves the physical object, the digital object also moves in concert with the physical object. The digital objects may also be icons or images. The movable user interface items may be moved as a result of user input, for example, hand or finger movements or by physically picking up tangibles and placing them on the surface. They may be moved to any location on the interactive surface, including the output region 202. The movable user interface items may have labels or marks to differentiate them from one another or they may be differentiated as a result of their shape and/or color.

When the movable user interface items are located in the active region 201 (excluding the output region 202) they produce an effect on the display shown in the output region 202. When the movable user interface items are located in the inactive region 207 or the output region 202 they have no effect on the display shown in the output region 202.

Associated with each movable user interface item is a stored query. The queries are stored at any suitable location, such as at the user interface controller 103 or at a memory accessible by the user interface controller over a communications network connection. Each query may comprise one or more search terms such as keywords or phrases. A query may also comprise an image of an object for finding other images of objects of the same class. The term “object class” is used to refer to a label assigned to an object indicating a group of objects of the same category or type. A non-exhaustive list of object classes is: buildings, motor vehicles, people, faces, animals, trees, sky, grass.

It is also possible for a query to comprise an example of an item for finding other items similar to the example. For example, the example may be a video clip and the query arranged to find similar video clips. The example may be a text message and the query arranged to find similar text messages.

When a movable user interface item is placed in the active region 201 this is detected by the user interface controller 103. The user interface controller 103 accesses the query associated with the particular movable user interface item and sends information about that query to the search engine. Information about documents retrieved by the search engine in response to the query is displayed in the output region 202. For example, the highest ranking document may be displayed in the output region 202.

In the example shown in FIG. 2, two movable user interface items 203, 204 are present in the active region 201. In this case two stored queries are accessed and sent to the search engine. The results of the search are then displayed in the output region 202.

In some embodiments the proximity of a movable user interface item to the output region is arranged to affect the amount of influence the associated query has on the search. Thus in the example shown in FIG. 2 the query associated with movable user interface item 204 may have greater influence on the search than the query associated with item 203 because items 204 is closest to the output region 202. For example, the queries may be weighted by amounts related to the distances of the movable user interface items from the output region 202. The relationship may be a linear relationship or any other suitable type of relationship. For example, the queries may be weighted by amounts proportional to the distances of the movable user interface items from the output region 202.

In some embodiments the user interface controller is arranged to display connecting lines 300, 301 or other connecting links between the movable user interface items 203, 204 that are in the active region and either the output region 202 or other movable user interface items. For example, these connecting links are created by the user interface controller according to a specified set of rules stored at the user interface controller. The connecting links may be displayed in order to represent a shortest path between a movable user interface item and the output region. By presenting connecting links in this way users are able to visually assess the relative distances of the movable user interface items from the output region.

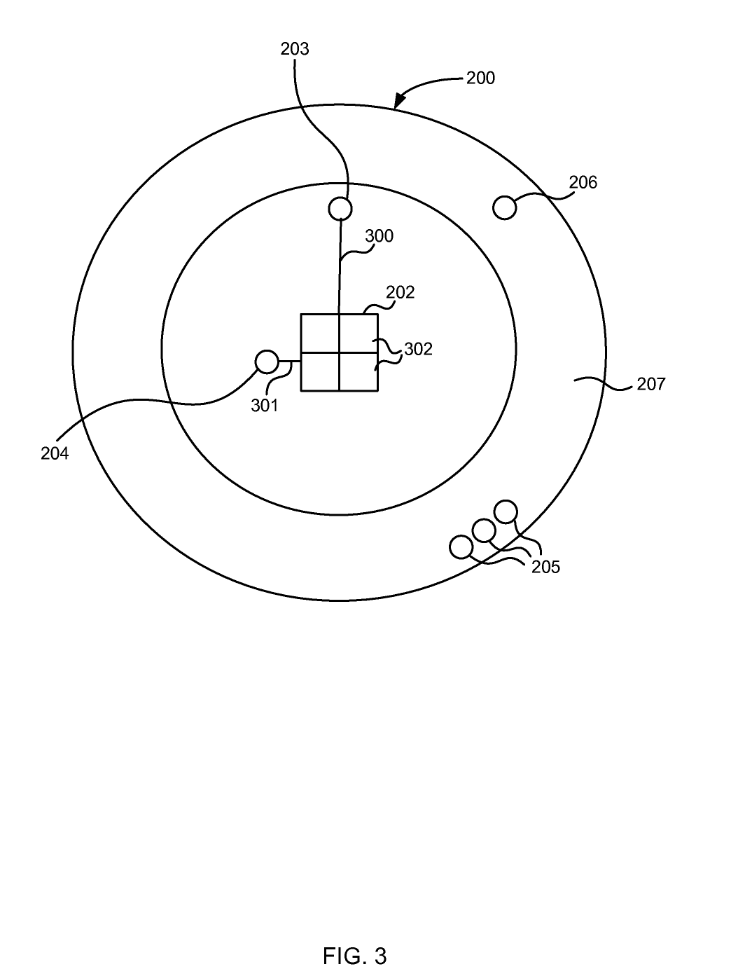

In the example shown in FIG. 3 the output region 202 is divided into four sub regions 302, each arranged to display one result document. In this case, the first four documents from a ranked list of documents retrieved by the search engine may be displayed. Other arrangements of sub regions in the output region 202 may be used.

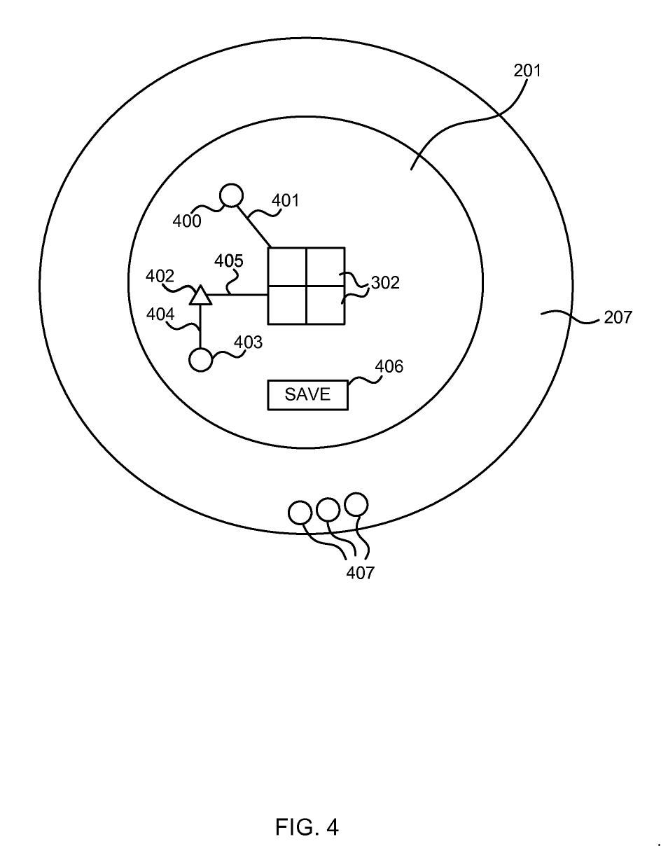

In the embodiment shown in FIG. 4 three movable user interface items 400, 402, 404 are shown in the active region 201. One of the movable user interface items 402 represents a query term which is an operator such as NOT. Two other movable user interface items 400, 403 represent query terms which are key words or images for example. Suppose that movable user interface item 400 is associated with key word “jaguar”. This key word is used as part of the search criteria and weighted in a manner related to the distance 401 of the movable user interface item from the output region 302. Suppose the movable user interface item 403 is associated with query word “car”. Because it is linked to movable user interface item 402 associated with the operator “not” the search proceeds for “jaguar not car” with jaguar weighted as described above.

Connecting links 405, 404 are displayed between the output region and movable user interface items 402 and 404 respectively. In some embodiments, where operators are used, no weighting of queries linked to the operator user interface item is done. In this case the lengths of connecting links 405, 404 have no influence on the search results. In other embodiments, one or more of these lengths do influence the search results.

In the example of FIG. 4 three movable user interface items 407 are shown in the inactive region 207. If the user wishes to save the current arrangement of movable user interface items in the active area 201 it is possible to select a user interface item 406. This creates a new movable user interface item which when placed in the active region 201 recreates the effect of the saved arrangement of movable user interface items. In this way, once a user or group of users has finalized an arrangement of user interface items for carrying out a search, this search can be carried out again at a later time in a simple and effective manner.

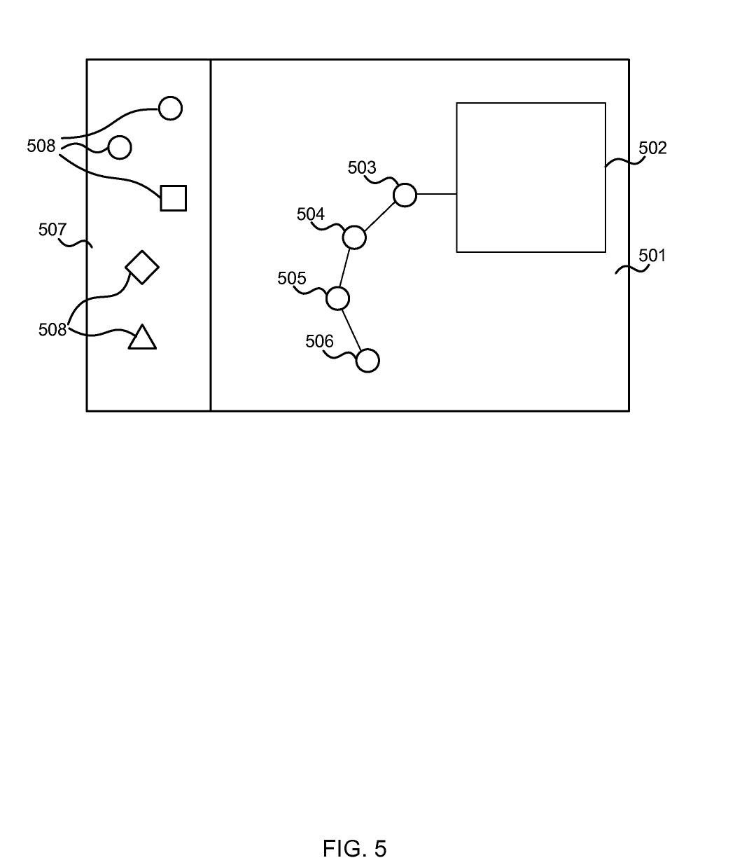

In the example of FIG. 5 a rectangular display is shown with an active region 501 adjacent an inactive region 507. The inactive region holds a plurality of movable user interface items 508 waiting to be used. The active region 501 encompasses an output region 502. Four movable user interface items 503, 504, 505, 506 are shown in the active region and these are linked in series and connected to the output region 502. Each movable user interface item has an associated stored query as described above. The queries are combined in any suitable manner, for example, using Boolean AND operators and provided to the search engine. The queries may optionally be weighted according to their relative order in the linked series. In another example, the queries may optionally be weighted according to their relative shortest-path distance from the output region 502.

The movable user interface items in the inactive region 507 may be pre-specified and/or may be created by a user. The process of creating a new movable user interface item comprises specifying an icon, shape or tangible to be used, and specifying a query to be stored in association with the icon, shape or tangible. This may be done in any suitable manner, such as using a graphical user interface. As described above with reference to FIG. 4 arrangements of one or more movable user interface items in the active region 201 may be saved and stored in association with a single new movable user interface item. The movable user interface items may also be deleted or edited (that is, the query associated with the movable user interface item may be edited). This is achieved using a suitable graphical user interface for example.

A movable user interface item comprising information about the icon, shape or tangible together with the stored query may be sent from one entity to another. For example, the movable user interface item may be attached to an email message or any other suitable type of message and sent to another entity. Movable user interface items may be received from other entities in a similar manner.

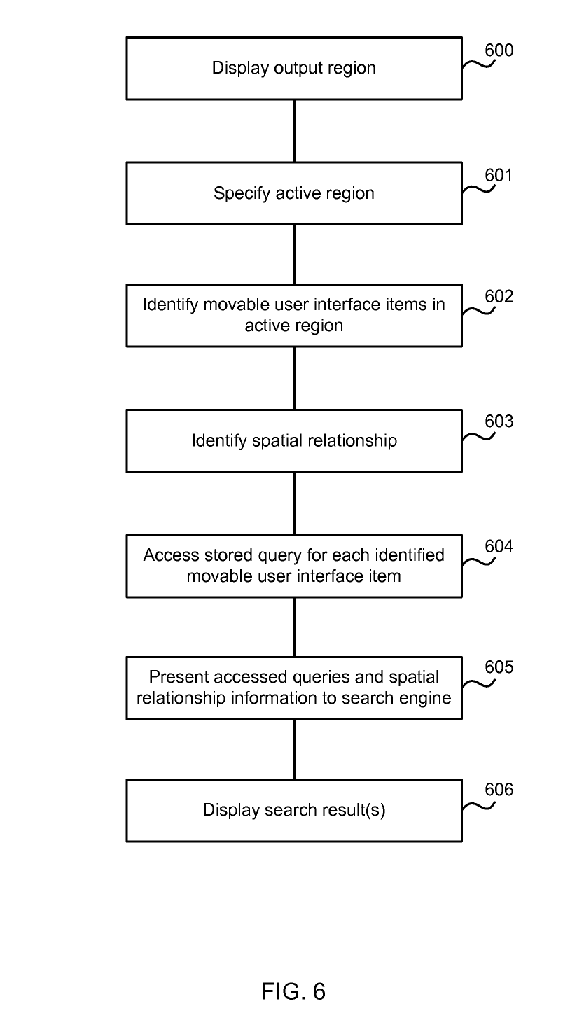

FIG. 6 is a block diagram of a computer-implemented method at a user interface controller arranged to control a display device comprising an interactive surface. The user interface controller renders 600 a display at the interactive surface comprising an output region arranged to display results from an information retrieval system. It also specifies 601 an active region around at least part of the output region. For example, the active region may be adjacent the output region and the two regions may or may not meet. In other examples the active region encompasses the output region.

The user interface controller is arranged to identify 602 any movable user interface items which are present in the active region and to identify a spatial relationship 603 of the movable user interface items and the output region. For example, this spatial relationship comprises information about distances of the movable user interface items from the output region. The distances may be relative or absolute. For example, the distances may be with respect to the output region. In other examples, this spatial relationship comprises information about both distances of the movable user interface items from the output region and information about distances of the movable user interface items from one another. Again the distances may be relative or absolute. In another example, the movable user interface items are connected in series and the spatial relationship comprises information about the series.

The user interface controller is arranged, for each of the identified movable user interface items, to access 604 a stored query. The accessed queries and the spatial relationship information are presented to a search engine of the information retrieval system. For example, the queries are combined using Boolean operators or in any other manner and are weighted or influenced in any other manner using information about the spatial relationship. The combined weighted queries are then presented 605 to the search engine and a ranked list of documents is obtained as a result. Information about the ranked list of documents is displayed 606 for example, by displaying the highest ranked document.

In an example the documents in the document database 100 are digital images such as photographs of objects. An automated object recognition system is used to pre-process the documents so that one or more labels is assigned to each image, indicating which of a plurality of specified object classes an image of an object in that image belongs to. A non-exhaustive list of object classes is: building, people, bicycle, cow, horse, aeroplane, car, sky, vegetation. A confidence value may also be provided by the automated object recognition system indicating a confidence that the label is assigned correctly. Any suitable automated object recognition system may be used such as that described in “LOCUS: Learning Object Classes with Unsupervised Segmentation” Proc. IEEE Intl. Conf. on Computer Vision (ICCV), Beijing 2005 which is incorporated herein by reference.

In the case that confidence values are associated with the object classes the movable user interface items are particularly able to facilitate effective information retrieval. This is because a user is able to adjust the spatial relationship between the movable interface item(s) and the output region in order to specify how much confidence is to be applied to the query. For example, suppose that a user requires images of cows but is only interested in images which are highly likely to be of cows. A movable user interface item is created associated with the stored query “cow”. The user places this movable user interface item in the active region at a position close to the output region for example. The user interface controller presents the query “cow” to the search engine together with information that only images with a high confidence level of containing an image of a cow are to be retrieved. Suppose that two images are found from the database both showing cows but which are unsuitable for the user's purposes for some other reason. The user may move the user interface item away from the output region in order to repeat the search with a lower confidence level. This time four images may be obtained, the two images from the first search, plus two others. The two other images have lower confidence of comprising an image of a cow but may be suitable for the user's purposes.

The examples described above use a single output region. However, it is also possible to use two or more output regions on the same interactive display. For example, each output region may display results of an information retrieval process on different document databases. It is also possible for the output regions to show results from the same document database. In this case, the spatial relationship of the movable user interface items from each output region may differ so that the search results shown in the output regions also differs.

The user interface provided promotes collaboration between users of an information retrieval system. More than one user is able to position the movable user interface items on the interactive surface at any one time. This enables the users to learn from one another and to achieve a better search result than may have been achieved when working alone. In addition, because the user interface items may be moved in an analog manner the users are able to achieve accurate weighting of queries in a simple, intuitive and effective manner that is not available with conventional text based search engine interfaces.

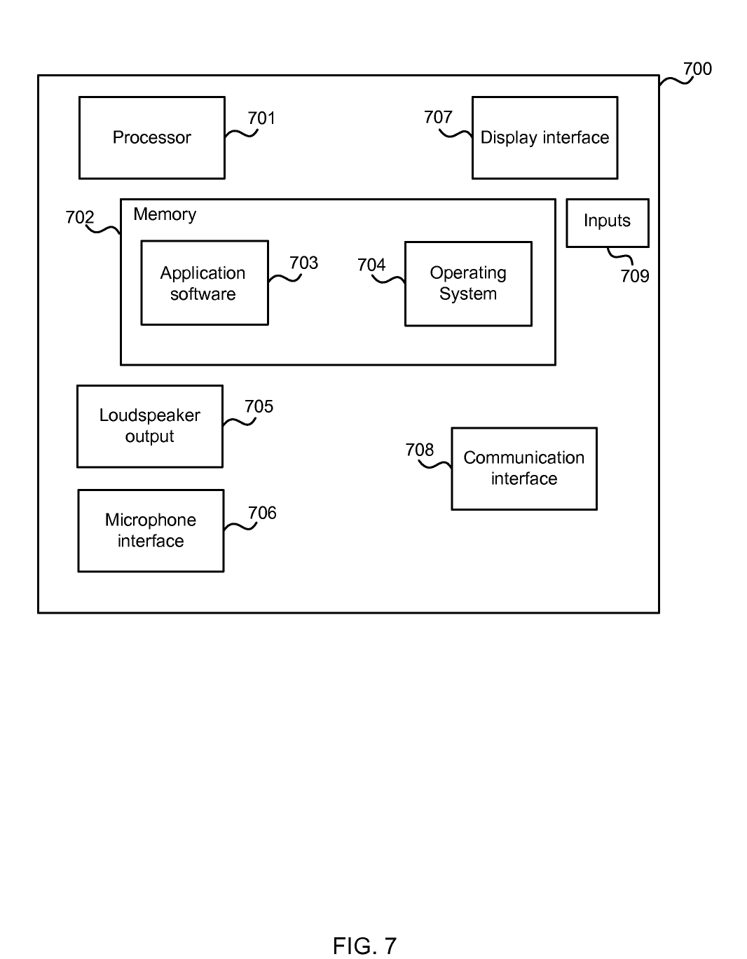

FIG. 7 illustrates various components of an exemplary computing-based device 700 which may be implemented as any form of a computing and/or electronic device, and in which embodiments of a user interface controller may be implemented.

The computing-based device 700 comprises one or more inputs 709 which are of any suitable type for receiving media content, Internet Protocol (IP) input, document information from a document database and inputs from a search engine. The device also comprises a display interface 707 for sending information for display at an interactive surface and also for receiving information such as user inputs from that display.

Computing-based device 700 also comprises one or more processors 701 which may be microprocessors, controllers or any other suitable type of processors for processing computing executable instructions to control the operation of the device in order to control a display device. Platform software comprising an operating system 704 or any other suitable platform software may be provided at the computing-based device to enable application software 703 to be executed on the device.

The computer executable instructions may be provided using any computer-readable media, such as memory 702. The memory is of any suitable type such as random access memory (RAM), a disk storage device of any type such as a magnetic or optical storage device, a hard disk drive, or a CD, DVD or other disc drive. Flash memory, EPROM or EEPROM may also be used. Outputs are provided such as an audio and/or video output to a display system (via the display interface 707) integral with or in communication with the computing-based device. A loudspeaker output 705 and a microphone interface 706 are optionally provided in the case that the display device comprises a microphone and a loudspeaker. A communication interface 708 is provided to enable the user interface controller to communicate with other entities over a communications network, for example, using email messages, or any other type of communication message.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or substantially simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method comprising:
displaying an output region on a display and specifying an active region around at least part of the output region;
identifying one or more movable user interface items located within the active region and identifying a spatial relationship of the movable user interface items and the output region;
for each identified user interface item accessing a stored query associated with that user interface item;
using the accessed queries and information about the spatial relationship to retrieve at least one document from a database comprising a plurality of documents;
displaying information related to the retrieved document in the output region.

2. A method as claimed in claim 1 wherein the step of identifying the spatial relationship comprises for each of the identified user interface items, determining a distance of that item from the output region.

3. A method as claimed in claim 2 wherein the step of presenting the accessed queries comprises weighting each query by its associated determined distance.

4. A method as claimed in claim 2 wherein the step of identifying the spatial relationship also comprises determining information related to distances of the movable user interface items from one another.

5. A method as claimed in claim 1 wherein the step of identifying the spatial relationship comprises determining that the identified user interface items are connected in series and determining that series.

6. A method as claimed in claim 1 wherein at least one of the stored queries comprises an image of an object.

7. A method as claimed in claim 1 wherein at least some of the movable user interface items are tangible objects.

8. A method as claimed in claim 1 wherein at least some of the movable user interface items are digital objects.

9. A method as claimed in claim 1 wherein the output region is divided into areas each arranged to display information related to a retrieved document.

10. A method as claimed in claim 1 which further comprises forming a new movable user interface item and storing a query in association with that new movable user interface item, the stored query corresponding to the identified movable user interface items and the identified spatial relationship.

11. A method as claimed in claim 1 which further comprises creating a message comprising a description of a movable user interface item and information related to its associated stored query and sending that message to another entity.

12. A method as claimed in claim 1 which further comprises, for at least one of the identified user interface items, accessing a query comprising an operator.

13. A computer-implemented method comprising:
displaying an output region on a display and specifying an active region around at least part of the output region;
identifying one or more movable user interface items located within the active region;
for each of the identified user interface items, determining a distance of that item from the output region;
for each identified user interface item accessing a stored query associated with that user interface item;
using the accessed queries and determined distances to retrieve at least one document from a database comprising a plurality of documents;
displaying information related to the retrieved document in the output region.

14. A method as claimed in claim 13 wherein the step of presenting the accessed queries comprises weighting each query by its associated determined distance.

15. One or more device-readable media with device-executable instructions for performing steps comprising:
displaying an output region on a display and specifying an active region around at least part of the output region;
identifying one or more movable user interface items located within the active region and identifying a spatial relationship of the movable user interface items and the output region;
for each identified user interface item, accessing a stored query associated with that user interface item;
using the accessed queries and information about the spatial relationship to retrieve at least one document from a database comprising a plurality of documents;
displaying information related to the retrieved document in the output region.

16. One or more device readable media as claimed in claim 15 further comprising device-executable instructions for performing steps comprising:
identifying the spatial relationship for each of the identified user interface items by determining a distance of that item from the output region.

17. One or more device readable media as claimed in claim 16 further comprising device-executable instructions for performing steps comprising presenting the accessed queries by weighting each query by its associated determined distance.

18. One or more device readable media as claimed in claim 16 further comprising device-executable instructions for performing steps comprising identifying the spatial relationship by determining distances of the movable user interface items from one another.

19. One or more device readable media as claimed in claim 15 further comprising device-executable instructions for performing steps comprising identifying the spatial relationship by determining that the identified user interface items are connected in series and determining that series.

20. One or more device readable media as claimed in claim 15 further comprising device-executable instructions for performing steps comprising creating a message comprising a description of a movable user interface item and information related to its associated stored query and sending that message to another entity.
